(19) United States
(12) Patent Application Publication
(10) Pub. No.: US 2025/0239398 A1
(43) Pub. Date: Jul. 24, 2025

(54) POWER INDUCTOR AND PREPARATION METHOD THEREFOR

(71) Applicant: HENGDIAN GROUP DMEGC MAGNETICS CO., LTD, Dongyang City Jinhua, Zhejiang (CN)

(72) Inventors: Yangdong YU, Dongyang City Jinhua, Zhejiang (CN); Leijie WANG, Dongyang City Jinhua, Zhejiang (CN); Kai LOU, Dongyang City Jinhua, Zhejiang (CN); Yangbin LU, Dongyang City Jinhua, Zhejiang (CN)

(21) Appl. No.: 18/700,667

(22) PCT Filed: Apr. 7, 2023
(86) PCT No.: PCT/CN2023/086929

§ 371 Date: Apr. 11, 2024

(30) Foreign Application Priority Data
Oct. 17, 2022 (CN) 202211265422.2

(51) Int. Cl. H01F 41/066; H01F 1/147; H01F 1/28; H01F 41/00; H01F 41/10

(52) U.S. Cl. CPC H01F 41/066; H01F 1/147; H01F 1/28; H01F 41/005; H01F 41/10

(57) ABSTRACT

Disclosed are a power inductor and a preparation method therefor, and the preparation method comprises the following steps: (1) casting a magnetic slurry to prepare a base magnetic sheet, a middle magnetic sheet, and a covering magnetic sheet individually; (2) placing the base magnetic sheet and the middle magnetic sheet in sequence from bottom to top, embedding coils, which are fixed on a thermo-sensitive adhesive at intervals in an array, into the middle magnetic sheet, and then compressing the covering magnetic sheet onto the top to form an inductor combination; and (3) cutting the inductor combination to obtain inductor units, and subjecting the inductor unit to curing, tumble spraying, laser paint stripping, electroplating, and a test in sequence to obtain the power inductor. The preparation method in the present application has a simple operation flow, few preparation processes, and a low preparation cost, which can realize a mass production of power inductors at one time, and has a prospect of large-scale industrial popularization and application.

### TECHNICAL FIELD

Examples of the present application relate to the technical field of inductors, for example, a power inductor and a preparation method therefor.

### BACKGROUND

At present, the mainstream power inductor is the integrated-compression molding inductor. Generally, such inductor is prepared by compressing an integrated molding inductor firstly, and then winding a wire on a center post of the pressed integrated molding inductor, and placing the integrated molding inductor having a wound coil in a mold cavity for powder filling and hot-pressing, and then performing subsequent processes such as tumble spraying and electroplating. However, the production efficiency of this process is low, and the compression molding is usually performed in an one-cavity-for-one-inductor unit for production. Meanwhile, the integrated molding has high requirements for compressor and mold, and the production cost of the inductor is stubbornly high due to the influence of tonnage of the press and the cost of the mold.

In addition, the required molding pressure of the integrated molding process of inductor is very large, and the coil inside the inductor is likely to have a large deformation, resulting in the phenomenon of copper exposure around the inductor, or damaging the insulating paint on the surface of the copper wire and resulting in an open circuit or a short circuit.

CN105355408A discloses a manufacturing method for a compression molding surface-mount inductor. Magnetic powder is used to manufacture a base, N bulges or N grooves are arranged on the base at intervals in an array, and then N coils are assembled outside N bulges or inside N grooves one-to-one to obtain an assembly of the N coils and the base. The assembly is placed in a mold cavity of a cold-pressing mold, the magnetic powder is filled into the mold cavity for cold compressing, and then subjected to hot compressing and baking to obtain an inductor parent blank; the inductor parent blank is cut along an array arrangement of the N coils to obtain N inductor bodies, and leading wires at two ends of the coils in each inductor body are exposed; finally, a post-process is performed to obtain the compression molding surface-mount inductor. However, in this method, in the case where the base is provided with the bulges at intervals in an array, the bulges are easy to break when the coils are sleeved outside the bulges; in the case where the base is provided with the grooves at intervals in an array, the coils are easy to move when the magnetic powder is filled, resulting in a disorder of the leading wires at both ends of the coils.

CN114188139A discloses a preparation method for a composite integrated inductor. The preparation method for an integrated inductor comprises the following steps: pressing magnetic core powder to prepare a magnetic core blank, and annealing the magnetic core blank to obtain a magnetic core; winding a coil on the prepared magnetic core to prepare a magnetic core coil; and setting shielding layer and electrodes on the prepared magnetic core coil to obtain the integrated inductor. By directly and individually prefabricating the magnetic core, a higher molding pressure can be employed to improve the compactness of the magnetic core, and at the same time the coil avoids the increment of direct-current impedance caused by compression deformation; under the individual prefabrication of the magnetic core, the magnetic core can be annealed at high temperature, so that the internal stress generated during the compression of magnetic core can be relieved, reducing the loss; the method for efficient winding wires of the wound inductor is combined, which can greatly improve the production efficiency of inductors, and is conducive to reducing the production cost. However, this method can only be performed in an one-cavity-for-one-inductor production mode, and has a low preparation efficiency of inductors.

CN114373626A discloses a preparation method for an integrated inductor with high frequency and high efficiency, which mainly includes mixing magnetic powder, a resin, a solvent, and other additives to prepare a magnetic slurry, and then injecting the magnetic slurry into a mold cavity with an coil fixed on for low-temperature baking at 60° C., after drying the solvent in the magnetic slurry, heating to 180° C. for high-temperature baking so as to cure the resin completely, and then demolding to obtain the finished product. However, the disadvantage of this method is: it takes a long time to dry the solvent at low temperature or cure the resin at high temperature, resulting in a low production efficiency.

Therefore, it is of great significance to develop a power inductor and a preparation method therefor to realize the preparation of hundreds of inductors in one molding process.

### SUMMARY

The following is a summary of the subject described herein. This summary is not intended to limit the protection scope of the claims.

An example of the present application provides a power inductor and a preparation method therefor. In the preparation method, a binder in a magnetic slurry contains a specific content of a resin, after the magnetic slurry is cast to prepare a base magnetic sheet, a middle magnetic sheet, and a covering magnetic sheet individually, and several arranged coils are embedded into the middle magnetic sheet one time, which realizes a mass production of power inductors at one time. The preparation method in the present application has a simple operation flow, few preparation processes, and a low preparation cost, and the obtained power inductors have excellent performance, which has a prospect of large-scale industrial popularization and application.

In a first aspect, an example of the present application provides a preparation method for a power inductor, and the preparation method comprises the following steps:
(1) casting a magnetic slurry to prepare a base magnetic sheet, a middle magnetic sheet, and a covering magnetic sheet individually;
(2) placing the base magnetic sheet and the middle magnetic sheet in sequence from bottom to top, embedding coils, which are fixed on a thermo-sensitive adhesive at intervals in an array, into the middle magnetic sheet, and then compressing the covering magnetic sheet onto the top to form an inductor combination; and
(3) cutting the inductor combination to obtain inductor units, and subjecting the inductor unit to curing, tumble spraying, laser paint stripping, electroplating, and a test in sequence to obtain the power inductor.

In the preparation method for the power inductor in the present application, the magnetic slurry is made into a base magnetic sheet, a middle magnetic sheet, and a covering magnetic sheet, then the base magnetic sheet and the middle magnetic sheet are placed in sequence from bottom to top, and then the coils, which are fixed on a thermo-sensitive adhesive at intervals in an array, are embedded into the middle magnetic sheet, and then the covering magnetic sheet is compressed on the top layer to form an inductor combination; the inductor combination is cut to obtain power inductors. In those steps, several arranged coils can be embedded into the magnet at one time, realizing a mass production of power inductors at one time. Compared with the conventional method that coils are placed in the magnetic powder to prepare a power inductor by the integrated-molding compression treatment, the preparation method in the present application can effectively avoid the deformation of coils, solve the problem of one cavity for one inductor in the integrated compression molding process, improve the production efficiency of the power inductor, and has few preparation processes and a low preparation cost, which has a prospect of industrial popularization and application.

Preferably, the magnetic slurry in step (1) comprises 1000 parts of soft magnetic alloy powder, 20-45 parts of a binder, 60-100 parts of an organic solvent, 3-8 parts of a toughening agent, 4-8 parts of a curing agent, and 0.5-2 parts of an accelerating agent, wherein the binder is 20-45 parts, which can be, for example, 20 parts, 25 parts, 30 parts, 35 parts, 40 parts, or 45 parts. However, the amount is not limited to the listed values, and other unlisted values within the numerical range are also applicable.

The organic solvent is 60-100 parts, which can be, for example, 60 parts, 70 parts, 80 parts, 90 parts, 95 parts, or 100 parts. However, the amount is not limited to the listed values, and other unlisted values within the numerical range are also applicable.

The toughening agent is 3-8 parts, which can be, for example, 3 parts, 4 parts, 5 parts, 6 parts, 7 parts, or 8 parts. However, the amount is not limited to the listed values, and other unlisted values within the numerical range are also applicable.

The curing agent is 4-8 parts, which can be, for example, 4 parts, 5 parts, 6 parts, 7 parts, 7.5 parts, or 8 parts. However, the amount is not limited to the listed values, and other unlisted values within the numerical range are also applicable.

The accelerating agent is 0.5-2 parts, which can be, for example, 0.5 parts, 0.8 parts, 1 part, 1.3 parts, 1.5 parts, or 2 parts. However, the amount is not limited to the listed values, and other unlisted values within the numerical range are also applicable.

Preferably, the soft magnetic alloy powder comprises any one or a combination of at least two of iron-silicon-aluminum powder, iron-silicon powder, iron-silicon-chromium powder, iron-nickel powder, amorphous powder, or nanocrystalline powder, wherein a typical but non-limiting combination comprises a combination of iron-silicon-aluminum powder and iron-silicon powder, a combination of iron-silicon-chromium powder and iron-nickel powder, a combination of nanocrystalline powder and iron-silicon-aluminum powder, or a combination of iron-silicon powder, iron-nickel powder, and nanocrystalline powder.

Preferably, the soft magnetic alloy powder has a particle size D50 of 15-40 μm, which can be, for example, 15 μm, 20 μm, 25 μm, 30 μm, 35 μm, or 40 μm; however, the D50 is not limited to the listed values, and other unlisted values within the numerical range are also applicable; D99 is less than or equal to 120 μm, which can be, for example, 120 μm, 115 μm, 100 μm, 90 μm, 70 μm, or 50 μm; however, the D99 is not limited to the listed values, and other unlisted values within the numerical range are also applicable.

In the present application, the soft magnetic alloy powder preferably has a particle size D50 of 15-40 μm, and a particle size D99 of less than or equal to 120 μm, which avoids that when the coils are embedded into the middle, the existence of coarse particles will cause too large extrusion deformation of coils.

Preferably, the binder comprises a thermosetting resin and a thermoplastic resin.

The preferred adhesive in the present application comprises a thermosetting resin and a thermoplastic resin, and the present application has a higher resin composition than that of the conventional magnetic slurry, and the resin can effectively form an insulating layer on the surface of the soft magnetic alloy powder particles, and thus the soft magnetic alloy material can obtain a low eddy current loss without passivation coating, simplifying the preparation process. When the binder is only the thermosetting resin, the toughness of the magnetic sheet is not satisfactory, the coils cannot be embedded into the magnet, and even if embedded into the magnet, the coils will be deformed greatly, and finally the qualified power inductor product cannot be produced; when the binder is only the thermoplastic resin, the strength of the obtained power inductor is not satisfactory, and finally the qualified power inductance product cannot be produced either.

Preferably, the thermosetting resin comprises an epoxy resin.

Preferably, the epoxy resin has an epoxy equivalent of 160-240 g/eq, which can be, for example, 160 g/eq, 170 g/eq, 190 g/eq, 200 g/eq, 210 g/eq, or 240 g/eq; however, the epoxy equivalent is not limited to the listed values, and other unlisted values within the numerical range are also applicable.

Preferably, the epoxy resin has a Tg temperature of 140-200° C., which can be, for example, 140° C., 150° C., 170° C., 180° C., 190° C., or 200° C.; however, the Tg temperature is not limited to the listed values, and other unlisted values within the numerical range are also applicable.

Preferably, the thermoplastic resin comprises any one or a combination of at least two of an acrylic resin, a polyvinyl acetal resin, or a butyral resin, wherein a typical but non-limiting combination comprises a combination of an acrylic resin and a polyvinyl acetal resin, a combination of a butyral resin and an acrylic resin, or a combination of an butyral resin, an acrylic resin, and a polyvinyl acetal resin.

Preferably, the thermoplastic resin has a molecular mass of 80000-200000 g/mol, which can be, for example, 80000 g/mol, 85000 g/mol, 90000 g/mol, 100000 g/mol, 150000 g/mol, or 200000 g/mol; however, the molecular mass is not limited to the listed values, and other unlisted values within the numerical range are also applicable.

Preferably, the thermoplastic resin has a Tg temperature of 80-120° C., which can be, for example, 80° C., 90° C., 100° C., 110° C., 115° C., or 120° C.; however, the Tg temperature is not limited to the listed values, and other unlisted values within the numerical range are also applicable.

Preferably, a mass ratio of the thermosetting resin to the thermoplastic resin is 3:1-1:1, which can be, for example, 3:1, 2.7:1, 2.5:1, 2:1, 1.5:1, or 1:1; however, the mass ratio is not limited to the listed values, and other unlisted values within the numerical range are also applicable.

The preferred mass ratio of the thermosetting resin to the thermoplastic resin in the present application is 3:1-1:1; when the proportion of the thermosetting resin is too high, the magnetic sheet will have a poor toughness when heated, the coils are easy to deform excessively when embedded into magnets, and the internal coils are prone to being cut in the subsequent cutting of the inductor combination, or the obtained power inductor will have a phenomenon of coil exposure; when the proportion of the thermosetting resin is low, the strength and temperature resistance of the cured power inductor will be reduced, and the power inductor cannot meet the technical requirements.

In the present application, the base magnetic sheet, the middle magnetic sheet, and the covering magnetic sheet, which are prepared by casting the magnetic slurry individually, can be prepared from different raw materials and different particle sizes, and the thicknesses of the base magnetic sheet, the middle magnetic sheet, and the covering magnetic sheet can be different.

Preferably, the organic solvent comprises a combination of at least two of ethanol, propanol, ethyl acetate, toluene, xylene, or acetone, wherein a typical but not-limiting combination comprises a combination of ethanol and propanol, a combination of ethyl acetate and toluene, a combination of propanol and toluene, or a combination of propanol, ethyl acetate, and toluene.

Preferably, the toughening agent comprises any one of polyethylene, polypropylene, polybutylene, or polystyrene.

Preferably, the curing agent comprises any one of m-phenylenediamine, diethyl toluenediamine, or m-xylylenediamine.

Preferably, the accelerating agent comprises any one of benzoyl peroxide, o-hydroxybenzoic acid, or tert-butyl perbenzoate.

Preferably, the coil in step (2) is provided with leading wires at two ends.

Preferably, the coil is formed by winding an enameled wire having a self-adhesive layer.

Preferably, a profile of the enameled wire comprises a round wire or a rectangle shape.

Preferably, an internal shape of the coil comprises a circle shape or an elliptical running-track shape.

Preferably, the thermo-sensitive adhesive has a releasing temperature of 100-135° C., which can be, for example, 100° C., 105° C., 110° C., 120° C., 133° C., or 135° C.; however, the adhesive-failure temperature is not limited to the listed values, and other unlisted values within the numerical range are also applicable.

Preferably, the thermo-sensitive adhesive has an adhesion of 800-1200 gf/25 mm, which can be, for example, 800 gf/25 mm, 850 gf/25 mm, 900 gf/25 mm, 1000 gf/25 mm, 1100 gf/25 mm, or 1200 gf/25 mm; however, the adhesion is not limited to the listed values, and other unlisted values within the numerical range are also applicable.

In the present application, the limitations of the releasing temperature and the adhesion of the thermo-sensitive adhesive are to ensure that it does not fall off during use, and is easy to be stripped off after use, so that the preparation process is simple and easy to be carried out.

Preferably, the coils are embedded into the middle magnetic sheet at a temperature of 80-135° C., allowed to stand with heat preservation for 20-60 s, wherein the heat preservation is perform at a temperature of 80-135° C., which can be, for example, 80° C., 90° C., 100° C., 110° C., 120° C., or 135° C.; however, the temperature is not limited to the listed values, and other unlisted values within the numerical range are also applicable; the heat preservation and standing are performed for 20-60 s, which can be, for example, 20 s, 25 s, 30 s, 40 s, 50 s, or 60 s; however, the period is not limited to the listed values, and other unlisted values within the numerical range are also applicable.

Preferably, a pressure at which the coils are embedded into the middle magnetic sheet is 20-40 MPa, which can be, for example, 20 MPa, 22 MPa, 25 MPa, 30 MPa, 35 MPa, or 40 MPa; however, the pressure is not limited to the listed values, and other unlisted values within the numerical range are also applicable.

In the present application, the reason why the coils are preferably embedded into the middle magnetic sheet at a temperature of 80-135° C. is that the base magnetic sheet, the middle magnetic sheet, and the covering magnetic sheet in the present application will be softened at a temperature of 80-135° C., which have good soft, and in the subsequent process, a magnet composed of high-strength and dense coils and magnetic sheets is obtained at a pressure as low as 20-40 MPa, and moreover, such temperature condition facilitates the releasing and removing of thermos-sensitive adhesive and in turn the subsequent operations.

Preferably, the compressing in step (2) is performed at a temperature of 100-150° C., which can be, for example, 100° C., 110° C., 120° C., 130° C., 140° C., or 150° C.; however, the temperature is not limited to the listed values, and other unlisted values within the numerical range are also applicable.

Preferably, the compressing in step (2) is performed at a pressure of 100-200 MPa, which can be, for example, 100 MPa, 110 MPa, 130 MPa, 150 MPa, 180 MPa, or 200 MPa; however, the pressure is not limited to the listed values, and other unlisted values within the numerical range are also applicable.

Preferably, the compressing is performed with a pressure-holding period of 10-40 s, which can be, for example, 10 s, 15 s, 20 s, 30 s, 35 s, or 40 s; however, the period is not limited to the listed values, and other unlisted values within the numerical range are also applicable.

Preferably, before the inductor unit in step (3) is cured, two terminals of the inductor unit are ground to a set size, so as to expose copper wire terminals at both ends of the coil.

As a preferred technical solution for the present application, the preparation method comprises the following steps:
(1) casting a magnetic slurry to prepare a base magnetic sheet, a middle magnetic sheet, and a covering magnetic sheet individually; the magnetic slurry comprises 1000 parts of soft magnetic alloy powder, 20-45 parts of a binder, 60-100 parts of an organic solvent, 3-8 parts of a toughening agent, 4-8 parts of a curing agent, and 0.5-2 parts of an accelerating agent; the soft magnetic alloy powder comprises any one or a combination of at least two of iron-silicon-aluminum powder, iron-silicon powder, iron-silicon-chromium powder, iron-nickel powder, amorphous powder, or nanocrystalline powder; the soft magnetic alloy powder has a particle size D50 of 15-40 μm and a particle size D99 of less than or equal to 120 μm; the binder comprises a thermosetting resin and a thermoplastic resin; the thermosetting resin comprises an epoxy resin, which has an epoxy equivalent of 160-240 g/eq, and a Tg temperature of 140-200° C.; the thermoplastic resin comprises any one or a combination of at least two of an acrylic resin, a polyvinyl acetal resin or a butyral resin; the thermoplastic resin has a molecular mass of 80000-200000 g/mol and a Tg temperature of 80-120° C.; a mass ratio of the thermosetting resin to the thermoplastic resin is 3:1-1:1; the organic solvent comprises a combination of at least two of ethanol, propanol, ethyl acetate, toluene, xylene, or acetone; the toughening agent comprises any one of polyethylene, polypropylene, polybutylene, or polystyrene; the curing agent comprises any one of m-phenylenediamine, diethyl toluenediamine, or m-xylylenediamine; the accelerating agent comprises any one of benzoyl peroxide, o-hydroxybenzoic acid, or tert-butyl perbenzoate;
(2) placing the base magnetic sheet and the middle magnetic sheet in sequence from bottom to top, allowing to stand with heat preservation at a temperature of 80-135° C. for 20-60 s, and embedding coils, which are fixed on a thermo-sensitive adhesive at intervals in an array, into the middle magnetic sheet at a pressure of 20-40 MPa, and then compressing the covering magnetic sheet onto the top to form an inductor combination;
the coil is provided with leading wires at two ends; the coil is formed by winding an enameled wire having a self-adhesive layer; the coils are arranged on the thermo-sensitive adhesive at intervals in an array, and fixed by adhesion;
the compressing has a temperature of 100-150° C., a pressure of 100-200 MPa, and a pressure-holding period of 10-40 s; and
(3) cutting the inductor combination to obtain inductor units; two terminals of the inductor unit are ground to a set size, so as to expose copper wire terminals at both ends of the coil, and then subjecting the inductor unit to curing, tumble spraying, laser paint stripping, electroplating, and a test in sequence to obtain the power inductor.

In a second aspect, an example of the present application also provides a power inductor, and the power inductor is prepared by the preparation method for a power inductor according to the first aspect; the power inductor comprises a base layer, a middle layer, and a covering layer in sequence from bottom to top; a coil is embedded in the middle layer.

Compared with the related art, examples of the present application have at least the following beneficial effects.

The preparation method for a power inductor provided in the examples of the present application has a simple operation process, few preparation processes, and a low preparation cost, and the obtained power inductor has excellent performance and is suitable for large-scale industrial popularization and application.

Other aspects can be understood upon reading and appreciating the accompanying drawings and detailed description.

### BRIEF DESCRIPTION OF DRAWINGS

Accompanying drawings are used to provide a further understanding of the technical solutions herein, form part of the specification, explain the technical solutions together with examples of the present application, and do not limit the technical solutions herein.

FIG. 1 is a schematic diagram showing a stacking state of a base magnetic sheet and a middle magnetic sheet in one example of the present application.

FIG. 2 is a schematic diagram showing coils fixed on a thermo-sensitive adhesive at intervals in an array in one example of the present application.

FIG. 3 is a schematic diagram showing coils embedded into a middle layer in one example of the present application.

FIG. 4 is a schematic diagram of an inductor combination in one example of the present application.

FIG. 5 is a schematic diagram of an inductor unit in one example of the present application.

FIG. 6 is a schematic diagram of a power inductor in one example of the present application.

Reference list: 1—base magnetic sheet, 2—middle magnetic sheet, 3—coil, 31—copper wire terminal, 4—covering magnetic sheet, 5—thermo-sensitive adhesive, 6—inductor unit, 7—power inductor.

### DETAILED DESCRIPTION

The technical solutions of the present application are further described below with reference to embodiments and accompanying drawings.

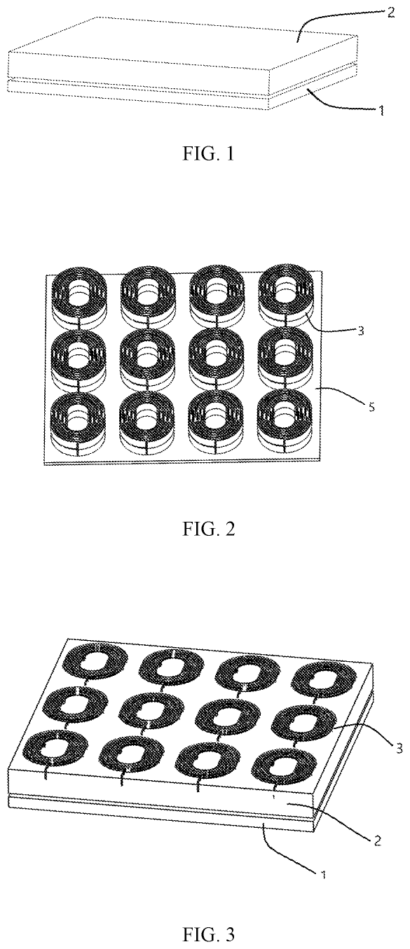

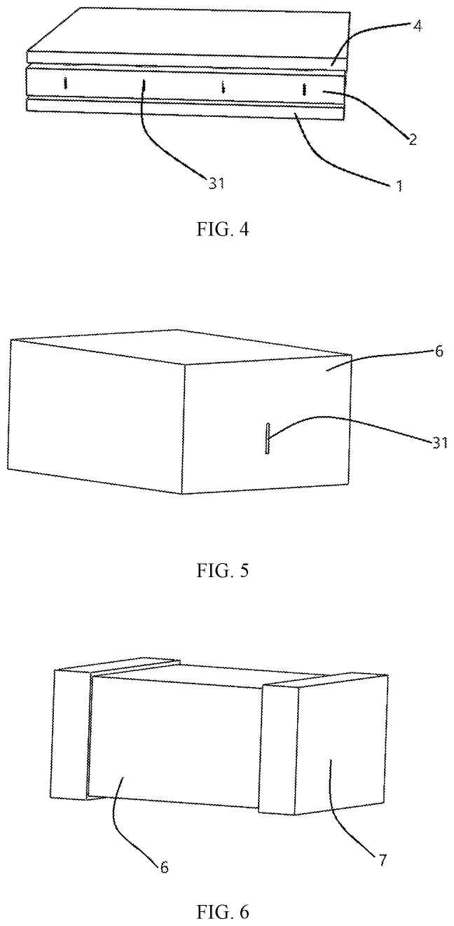

The present application provides a preparation method for a power inductor, and the preparation method comprises the following steps:
(1) a magnetic slurry is cast to prepare a base magnetic sheet 1, a middle magnetic sheet 2, and a covering magnetic sheet 4 individually;
(2) the base magnetic sheet 1 and the middle magnetic sheet 2 are placed in sequence from bottom to top (as shown in FIG. 1), coils 3, which are fixed on a thermo-sensitive adhesive 5 at intervals in an array (as shown in FIG. 2), are embedded into the middle magnetic sheet 2 (as shown in FIG. 3), and then the covering magnetic sheet 4 is compressed onto the top to form an inductor combination (as shown in FIG. 4); and
(3) the inductor combination is cut to obtain inductor units 6; two terminals of the inductor unit 6 are ground to a set size, so as to expose copper wire terminals 31 at two ends of the coil (as shown in FIG. 5), and then the inductor unit is sequentially subjected to curing, tumble spraying, laser paint stripping, electroplating, and a test to obtain the power inductor 7 (as shown in FIG. 6).

The present application is further described in detail below. However, the following examples are only simple examples of the present application, and do not represent or limit the protection scope of claims in the present application, and the protection scope of the present application is defined by the claims.

### Example 1

This example provides a preparation method for a power inductor, and the preparation method comprises the following steps:
(1) a magnetic slurry was cast to prepare a base magnetic sheet, a middle magnetic sheet, and a covering magnetic sheet individually; wherein the thickness of the base magnetic sheet and the thickness of the covering magnetic sheet were both 0.33±0.01 mm, and the thickness of the middle magnetic sheet was 0.65±0.02 mm;
the magnetic slurry comprised 1000 parts of soft magnetic alloy powder, 30 parts of a binder, 80 parts of an organic solvent which comprised ethanol and propanol in a volume ratio of 1:1, 4.5 parts of a toughening agent polyethylene, 4.5 parts of a curing agent m-phenylenediamine, and 0.8 parts of an accelerating agent benzoyl peroxide; the soft magnetic alloy powder was a mixture of iron-nickel powder and iron-silicon-aluminum powder with a mass ratio of 1:1, wherein the iron-nickel powder had a D50 of 21.6 μm and a D99 of 40.4 μm, the iron-silicon-aluminum powder had a D50 of 22.9 μm and a D99 of 96.36 μm; the binder was prepared by mixing an epoxy resin with an epoxy equivalent of 190±5 g/eq and a T_{g} of 168° C., and an acrylic resin with a molecular mass of 120000 g/mol and a T_{g} of 98° C. according to a mass ratio of 2:1;
(2) the base magnetic sheet and the middle magnetic sheet were placed in sequence from bottom to top, and allowed to stand with heat preservation at a temperature of 100° C. for 30 s, and then at a pressure of 26 MPa, coils, which were fixed on a thermo-sensitive adhesive at intervals in an array, were embedded into the middle magnetic sheet and kept at the pressure for 20 s, and then the covering magnetic sheet was compressed onto the top to form an inductor combination;
the coil was provided with leading wires at two ends; the coil was formed by winding an enameled wire having a self-adhesive layer, and the enameled wire was a rectangle wire with a thickness of 0.09 mm and a width of 0.3 mm, and wound in 2 layers for a total of 7.5 turns; the coil had an elliptical running-track shape inside; and the coils were arranged on the thermal adhesive at intervals in an array, and fixed by adhesion; after the coils were compressed, an upper compressing plate was drawn back, a lower mold cavity was moved out and cooled, and the thermo-sensitive adhesive was stripped off after adhesive failure; the compressing had a temperature of 100° C., a pressure of 150 MPa, and a pressure-holding period of 20 s; and
(3) the inductor combination was cut to obtain inductor units; two terminals of the inductor unit were ground to a set size, so as to expose copper wire terminals at both ends of the coil, and then the inductor unit was sequentially subjected to curing, tumble spraying, laser paint stripping, electroplating, and a test to obtain the power inductor.

### Example 2

This example provides a preparation method for a power inductor, and the preparation method comprises the following steps:
(1) a magnetic slurry was cast to prepare a base magnetic sheet, a middle magnetic sheet, and a covering magnetic sheet individually; wherein the thickness of the base magnetic sheet and the thickness of the covering magnetic sheet were both 0.33±0.01 mm, and the thickness of the middle magnetic sheet was 0.65±0.02 mm;
the magnetic slurry comprised 1000 parts of soft magnetic alloy powder, 40 parts of a binder, 100 parts of an organic solvent which comprised ethyl acetate and toluene in a volume ratio of 1:1, 6 parts of a toughening agent polybutylene, 6.75 parts of a curing agent diethyl toluenediamine, and 1.2 parts of an accelerating agent tert-butyl perbenzoate; the soft magnetic alloy powder was a mixture of iron-nickel powder and iron-silicon-aluminum powder with a mass ratio of 1:1, wherein the iron-nickel powder had a D50 of 21.6 μm and a D99 of 40.4 μm, the iron-silicon-aluminum powder had a D50 of 22.9 μm and a D99 of 96.36 μm; the binder was prepared by mixing an epoxy resin with an epoxy equivalent of 170±5 g/eq and a T_{g} of 149° C., and an acrylic resin with a molecular mass of 100000 g/mol and a T_{g} of 86° C. according to a mass ratio of 3:1;
(2) the base magnetic sheet and the middle magnetic sheet were placed in sequence from bottom to top, and allowed to stand with heat preservation at a temperature of 80° C. for 40 s, and then at a pressure of 36 MPa, coils, which were fixed on a thermo-sensitive adhesive at intervals in an array, were embedded into the middle magnetic sheet with a pressure-holding period of 30 s, and then the covering magnetic sheet was compressed onto the top to form an inductor combination;
the coil was provided with leading wires at two ends; the coil was formed by winding an enameled wire having a self-adhesive layer, and the enameled wire was a rectangle wire with a thickness of 0.09 mm and a width of 0.3 mm, and wound in 2 layers for a total of 7.5 turns; the coil had an elliptical running-track shape inside; the coils were arranged on the thermal adhesive at intervals in an array, and fixed by adhesion; after the coils were compressed, an upper compressing plate was drawn back, a lower mold cavity was moved out and cooled, and the thermo-sensitive adhesive was stripped off after adhesive failure; the compressing had a temperature of 120° C., a pressure of 180 MPa, and a pressure-holding period of 10 s; and
(3) the inductor combination was cut to obtain inductor units; two terminals of the inductor unit were ground to a set size, so as to expose copper wire terminals at both ends of the coil, and then the inductor unit was sequentially subjected to curing, tumble spraying, laser paint stripping, electroplating, and a test to obtain the power inductor.

### Example 3

This example provides a preparation method for a power inductor, and the preparation method comprises the following steps:
(1) a magnetic slurry was cast to prepare a base magnetic sheet, a middle magnetic sheet, and a covering magnetic sheet individually; wherein the thickness of the base magnetic sheet and the thickness of the covering magnetic sheet were both 0.30±0.01 mm, and the thickness of the middle magnetic sheet was 0.7±0.02 mm;
the magnetic slurry comprised 1000 parts of soft magnetic alloy powder, 24 parts of a binder, 75 parts of an organic solvent which comprised ethyl acetate and xylene in a volume ratio of 1:1, 5.5 parts of a toughening agent polystyrene, 4.05 parts of a curing agent m-xylylenediamine, and 0.72 parts of an accelerating agent o-hydroxybenzoic acid; the soft magnetic alloy powder was a mixture of iron-nickel powder and iron-silicon-aluminum powder with a mass ratio of 2:1, wherein the iron-nickel powder had a D50 of 23.53 μm and a D99 of 88.47 μm, the iron-silicon-aluminum powder had a D50 of 22.9 μm and a D99 of 96.36 μm; the binder was prepared by mixing an epoxy resin with an epoxy equivalent of 190±5 g/eq and a T_{g} of 168° C., and an acrylic resin with a molecular mass of 180000 g/mol and a T_{g} of 104° C. according to a mass ratio of 3:1;
(2) the base magnetic sheet and the middle magnetic sheet were placed in sequence from bottom to top, and allowed to stand with heat preservation at a temperature of 120° C. for 20 s, and then at a pressure of 22 MPa, coils, which were fixed on a thermo-sensitive adhesive at intervals in an array, were embedded into the middle magnetic sheet with a pressure-holding period of 25 s, and then the covering magnetic sheet was compressed onto the top to form an inductor combination;
the coil was provided with leading wires at two ends; the coil was formed by winding an enameled wire having a self-adhesive layer, and the enameled wire was a rectangle wire with a thickness of 0.08 mm and a width of 0.32 mm, and wound in 2 layers for a total of 8.5 turns; the coil had an elliptical running-track shape inside; the coils were arranged on the thermal adhesive at intervals in an array, and fixed by adhesion; after the coils were compressed, an upper compressing plate was drawn back, a lower mold cavity was moved out and cooled, and the thermo-sensitive adhesive was stripped off after adhesive failure; the compressing had a temperature of 140° C., a pressure of 120 MPa, and a pressure-holding period of 35 s; and
(3) the inductor combination was cut to obtain inductor units; two terminals of the inductor unit were ground to a set size, so as to expose copper wire terminals at two ends of the coil, and then the inductor unit was sequentially subjected to curing, tumble spraying, laser paint stripping, electroplating, and a test to obtain the power inductor.

### Example 4

This example provides a preparation method for a power inductor, and the preparation method comprises the following steps:
(1) a magnetic slurry was cast to prepare a base magnetic sheet, a middle magnetic sheet, and a covering magnetic sheet individually; wherein the thickness of the base magnetic sheet and the thickness of the covering magnetic sheet were both 0.33±0.01 mm, and the thickness of the middle magnetic sheet was 0.65±0.02 mm;
the magnetic slurry comprised 1000 parts of soft magnetic alloy powder, 36 parts of a binder, 90 parts of an organic solvent which comprised propanol and ethyl acetate in a volume ratio of 1:1, 6 parts of a toughening agent polypropylene, 4.05 parts of a curing agent m-xylylenediamine, and 0.72 parts of an accelerating agent benzoyl peroxide; the soft magnetic alloy powder was a mixture of iron-nickel powder and iron-silicon-aluminum powder with a mass ratio of 1:1, wherein the iron-nickel powder had a D50 of 21.6 μm and a D99 of 40.4 μm, the iron-silicon-aluminum powder had a D50 of 22.9 μm and a D99 of 96.36 μm; the binder was prepared by mixing an epoxy resin with an epoxy equivalent of 170±10 g/eq and a T_{g} of 149° C., and an acrylic resin with a molecular mass of 100000 g/mol and a T_{g} of 86° C. according to a mass ratio of 1:1;
(2) the base magnetic sheet and the middle magnetic sheet were placed in sequence from bottom to top, and allowed to stand with heat preservation at a temperature of 90° C. for 45 s, and then at a pressure of 30 MPa, coils, which were fixed on a thermo-sensitive adhesive at intervals in an array, were embedded into the middle magnetic sheet with a pressure-holding period of 35 s, and then the covering magnetic sheet was compressed onto the top to form an inductor combination;
the coil was provided with leading wires at two ends; the coil was formed by winding an enameled wire having a self-adhesive layer, and the enameled wire was a rectangle wire with a thickness of 0.09 mm and a width of 0.3 mm, and wound in 2 layers for a total of 7.5 turns; the coil had an elliptical running-track shape inside; the coils were arranged on the thermal adhesive at intervals in an array, and fixed by adhesion; after the coils were compressed, an upper compressing plate was drawn back, a lower mold cavity was moved out and cooled, and the thermo-sensitive adhesive was stripped off after adhesive failure; the compressing had a temperature of 110° C., a pressure of 160 MPa, and a pressure-holding period of 25 s; and
(3) the inductor combination was cut to obtain inductor units; two terminals of the inductor unit were ground to a set size, so as to expose copper wire terminals at two ends of the coil, and then the inductor unit was sequentially subjected to curing, tumble spraying, laser paint stripping, electroplating, and a test to obtain the power inductor.

### Example 5

This example provides a preparation method for a power inductor. In the preparation method, except that the mass ratio of the thermosetting resin to the thermoplastic resin of 2:1 is replaced with 4:1 in step (1), the rest are the same as in Example 1.

### Example 6

This example provides a preparation method for a power inductor. In the preparation method, except that the mass ratio of the thermosetting resin to the thermoplastic resin of 2:1 is replaced with 1:2 in step (1), the rest are the same as in Example 1.

### Example 7

This example provides a preparation method for a power inductor. In the preparation method, in step (1), except that the temperature of 100° C. at which the coils are embedded into the middle magnetic sheet is replaced with 70° C., the rest are the same as in Example 1.

### Example 8

This example provides a preparation method for a power inductor. In the preparation method, in step (1), except that the temperature of 100° C. at which the coils are embedded into the middle magnetic sheet is replaced with 150° C., the rest are the same as in Example 1.

An inductance value, a temperature-rise current and a saturation current of the power inductors obtained in the above examples are tested with a Wayne Kerr WK6500B impedance analyzer under the condition of 1 MHz; a direct-current resistance of the power inductors is tested with a HIOKI RM3542 resistance meter, and the results are shown in Table 1. The inductor units are observed with a microscope, and appearance defects are shown in Table 1.

TABLE 1

| | | [symbol] emperature- | | [symbol] irect- | [symbol] earance |
|---|---|---|---|---|---|
| | [symbol] ctance | rise | [symbol] ration | current | defects of |
| | value | current | current | resistance | inductor |
| | Ls (μH) | Itemp (A) | Isat (A) | Rdc (mΩ) | unit |
| [symbol] xample 1 | 0.96 | 5.5 | 5.6 | 41 | No |
| [symbol] xample 2 | 1.08 | 5.4 | 5.5 | 41 | No |
| [symbol] xample 3 | 2.22 | 4.5 | 4.6 | 41.5 | No |
| [symbol] xample 4 | 2.08 | 4.4 | 4.6 | 41.5 | No |
| [symbol] xample 5 | 0.65 | / | / | 41 | [symbol] agnetic sheet |
| | | | | | delaminating |
| [symbol] xample 6 | 0.78 | / | / | 41 | [symbol] orner lost |
| | | | | | and magnet |
| | | | | | falling off |
| [symbol] xample 7 | 0.58 | / | / | 41 | oil exposure |
| [symbol] xample 8 | 0.84 | / | / | 41 | [symbol] agnetic sheet |
| | | | | | delaminating |

The “/” in Table 1 represents that no data is available. [symbol]
indicates data missing or illegible when filed

As can be seen from Table 1:
(1) from Example 1 and Examples 5-6, it can be seen that when the proportion of the thermosetting resin in Example 5 is too high, microscopic observation of the cut obtained inductor unit reveals that there is a phenomenon of “delamination” between the covering magnetic sheet and the middle magnetic sheet, resulting in the final obtained power inductor has a decreased inductance value as low as 0.65 μH; when the proportion of thermosetting resin in Example 6 is low, the cured power inductor has an insufficient hardness, and undergoes defects such as “corner lost” and “magnet falling off” during tumble spraying, and the inductance value is also greatly reduced; and
(2) from Example 1 and Examples 7-8, it can be seen that because the coils in Example 7 are embedded into the middle magnetic sheet at a low temperature, the middle magnetic sheet is hard; under the same pressure as in Example 1, the coils cannot be well embedded into the middle magnetic sheet, the inductor unit obtained after the cutting has exposed coils, and the coils of some inductor units are cut off; and by industrial CT characterization, it is found that the outer diameter of the coils is increased due to the large expansion of the coils, and the inductance value of the power inductor is also greatly reduced; because the coils in Example 8 are embedded into the middle magnetic sheet at a high temperature, a large amount of adhesive remains on the surface of the embedded coils when the thermos-sensitive adhesive is stripped off; in addition, by observing the inductor unit obtained after the cutting via a microscope, it is found that there is phenomenon of “delamination” between the covering magnetic sheet and the middle magnetic sheet, resulting in a decrease in the inductance value of the final obtained power inductor.

In summary, in the present application, a specific magnetic slurry is adopted to prepare magnetic sheets, and several arranged coils are embedded into the middle magnetic sheet at a specific temperature, and an inductor combination containing several qualified power inductors can be obtained by compression molding one time, and then subjected to cutting and a subsequent operation to obtain qualified power inductors with excellent performance, which solves the problem of one cavity for one inductor in the integrated compression molding process, improves the production efficiency of the power inductor, and has a prospect of industrial popularization and application.

The applicant declares that the above is only embodiments of the present application, but the protection scope of the present application is not limited thereto. It should be understood by those skilled in the art that any changes or replacements that can be easily thought of, within the technical scope disclosed by the present application, shall fall within the protection scope and disclosure scope of the present application.

What is claimed is:

1. A preparation method for a power inductor, comprising the following steps:
(1) casting a magnetic slurry to prepare a base magnetic sheet, a middle magnetic sheet, and a covering magnetic sheet individually;
(2) placing the base magnetic sheet and the middle magnetic sheet in sequence from bottom to top, embedding coils, which are fixed on a thermo-sensitive adhesive at intervals in an array, into the middle magnetic sheet, and then compressing the covering magnetic sheet onto the top to form an inductor combination; and
(3) cutting the inductor combination to obtain inductor units, and subjecting the inductor unit to curing, tumble spraying, laser paint stripping, electroplating, and a test in sequence to obtain the power inductor.

2. The preparation method according to claim 1, wherein the magnetic slurry in step (1) comprises 1000 parts of a soft magnetic alloy powder, 20-45 parts of a binder, 60-100 parts of an organic solvent, 3-8 parts of a toughening agent, 4-8 parts of a curing agent, and 0.5-2 parts of an accelerating agent.

3. The preparation method according to claim 2, wherein the soft magnetic alloy powder comprises any one or a combination of at least two of iron-silicon-aluminum powder, iron-silicon powder, iron-silicon-chromium powder, iron-nickel powder, amorphous powder, or nanocrystalline powder.

4. The preparation method according to claim 2, wherein the soft magnetic alloy powder has a particle size D50 of 15-40 μm and a particle size D99 of less than or equal to 120 μm.

5. The preparation method according to claim 2, wherein the binder comprises a thermosetting resin and a thermoplastic resin;
preferably, the thermosetting resin comprises an epoxy resin;
preferably, the epoxy resin has an epoxy equivalent of 160-240 g/eq;
preferably, the epoxy resin has a Tg temperature of 140-200° C.;
preferably, the thermoplastic resin comprises any one or a combination of at least two of an acrylic resin, a polyvinyl acetal resin, or a butyral resin;
preferably, the thermoplastic resin has a molecular mass of 80000-200000 g/mol;
preferably, the thermoplastic resin has a Tg temperature of 80-120° C.;
preferably, a mass ratio of the thermosetting resin to the thermoplastic resin is 3:1-1:1.

6. The preparation method according to claim 2, wherein the organic solvent comprises a combination of at least two of ethanol, propanol, ethyl acetate, toluene, xylene, or acetone;
preferably, the toughening agent comprises any one of polyethylene, polypropylene, polybutylene, or polystyrene;
preferably, the curing agent comprises any one of m-phenylenediamine, diethyl toluenediamine, or m-xylylenediamine;
preferably, the accelerating agent comprises any one of benzoyl peroxide, o-hydroxybenzoic acid, or tert-butyl perbenzoate.

7. The preparation method according to claim 1, wherein the coil in step (2) is provided with leading wires at two ends;
preferably, the coil is formed by winding an enameled wire having a self-adhesive layer.

8. The preparation method according to claim 1, wherein the compressing in step (2) is performed at a temperature of 100-150° C.

9. The preparation method according to claim 1, wherein before the inductor unit in step (3) is cured, two terminals of the inductor unit are ground to a set size, so as to expose copper wire terminals at two ends of the coil.

10. The preparation method according to claim 1, comprising the following steps:
(1) casting a magnetic slurry to prepare a base magnetic sheet, a middle magnetic sheet, and a covering magnetic sheet individually;
the magnetic slurry comprises 1000 parts of soft magnetic alloy powder, 20-45 parts of a binder, 60-100 parts of an organic solvent, 3-8 parts of a toughening agent, 4-8 parts of a curing agent, and 0.5-2 parts of an accelerating agent; the soft magnetic alloy powder comprises any one or a combination of at least two of iron-silicon-aluminum powder, iron-silicon powder, iron-silicon-chromium powder, iron-nickel powder, amorphous powder, or nanocrystalline powder; the soft magnetic alloy powder has a particle size D50 of 15-40 μm and a particle size D99 of less than or equal to 120 μm; the binder comprises a thermosetting resin and a thermoplastic resin; the thermosetting resin comprises an epoxy resin, which has an epoxy equivalent of 160-240 g/eq and a T_{g} temperature of 140-200° C.; the thermoplastic resin comprises any one or a combination of at least two of an acrylic resin, a polyvinyl acetal resin or a butyral resin; the thermoplastic resin has a molecular mass of 80000-200000 g/mol and a Tg temperature of 80-120° C.; a mass ratio of the thermosetting resin to the thermoplastic resin is 3:1-1:1; the organic solvent comprises a combination of at least two of ethanol, propanol, ethyl acetate, toluene, xylene, or acetone; the toughening agent comprises any one of polyethylene, polypropylene, polybutylene, or polystyrene; the curing agent comprises any one of m-phenylenediamine, diethyl toluenediamine, or m-xylylenediamine; the accelerating agent comprises any one of benzoyl peroxide, o-hydroxybenzoic acid, or tert-butyl perbenzoate;
(2) placing the base magnetic sheet and the middle magnetic sheet in sequence from bottom to top, allowing to stand with heat preservation at a temperature of 80-135° C. for 20-60 s, and embedding coils, which are fixed on a thermo-sensitive adhesive at intervals in an array, into the middle magnetic sheet at a pressure of 20-40 MPa, and then compressing the covering magnetic sheet onto the top to form an inductor combination;
the coil is provided with leading wires at two ends; the coil is formed by winding an enameled wire having a self-adhesive layer; the compressing is performed at a temperature of 100-150° C. and a pressure of 100-200 MPa with a pressure-holding period of 10-40 s; and
(3) cutting the inductor combination to obtain inductor units; two terminals of the inductor unit are ground to a set size, so as to expose copper wire terminals at two ends of the coil, and then subjecting the inductor unit to curing, tumble spraying, laser paint stripping, electroplating, and a test in sequence to obtain the power inductor.

11. A power inductor, which is prepared by the preparation method for a power inductor according to claim 1;
the power inductor comprises a base layer, a middle layer, and a covering layer in sequence from bottom to top; coils are embedded into the middle layer.

12. The preparation method according to claim 1, wherein the coils are embedded into the middle magnetic sheet at a temperature of 80-135° C., and allowed to stand with heat preservation for 20-60 s in step (2).

13. The preparation method according to claim 1, wherein a pressure at which the coils are embedded into the middle magnetic sheet is 20-40 MPa in step (2).

14. The preparation method according to claim 1, wherein the compressing in step (2) is performed at a pressure of 100-200 MPa.

15. The preparation method according to claim 1, wherein the compressing in step (2) is performed with a pressure-holding period of 10-40 s.
